(19) United States
(12) Patent Application Publication
(10) Pub. No.: US 2009/0089859 A1
(43) Pub. Date: Apr. 2, 2009

(54) Method and apparatus for detecting phishing attempts solicited by electronic mail

(76) Inventors: Debra L. Cook, Tinton Falls, NJ (US); Michael Alexander Daniluk, Woodside, NY (US); Vijay K. Gurbani, Lisle, IL (US)

Correspondence Address: Docket Administrator - Room 2F-192;Alcatel-Lucent USA Inc., 600-700 Mountain Avenue, Murray Hill, NJ, 07974, US

(21) Appl. No.: 11/906,017

(22) Filed: Sep. 28, 2007

(51) Int. Cl. H04L 9/32

(52) U.S. Cl. 726/3

(57) ABSTRACT

A phishing filter employs a plurality of heuristics or rules (in one embodiment, 12 rules) to detect and filter phishing attempts solicited by electronic mail. Generally, the rules fall within the following categories: (1) identification and analysis of the login URL (i.e., the “actual” URL) in the email, (2) analysis of the email headers, (3) analysis across URLs and images in the email other than the login URL, and (4) determining if the URL is accessible. The phishing filter does not need to be trained, does not rely on black or white lists and does not perform keyword analysis. The filter may be implemented as an alternative or supplemental to prior art spam detection filters.

### FIELD OF THE INVENTION

This invention relates generally to electronic mail filtering and, more particularly, to a method and apparatus for detecting and filtering “phishing” attempts solicited by electronic mail.

### BACKGROUND OF THE INVENTION

Electronic mail (“email”) services are well known, whereby users equipped with devices including, for example, personal computers, laptop computers, mobile telephones, Personal Digital Assistants (PDAs) or the like, can exchange email transmissions with other such devices or network devices. A major problem associated with email service is the practice of “phishing,” a form of unsolicited email, or spam, where a spammer sends an email that directs a user to a fraudulent website with the intent of obtaining personal information of the user for illicit purposes. For example, a phishing email is typically constructed so as to appear to originate from a legitimate service entity (e.g., banks, credit card issuers, e-commerce enterprises) and a link in the email directs the user to what appears to be a legitimate website of the service entity, but in reality the website is a bogus site maintained by an untrusted third party. Once directed to the fraudulent site, an unwitting user can be tricked into divulging personal information including, for example, passwords, user names, personal identification numbers, bank and brokerage account numbers and the like, thereby putting the user at risk of identity theft and financial loss. Many service entities have suffered substantial financial losses as a result of their clients being victimized by the practice of phishing. Thus, there is a continuing need to develop strategies and mechanisms to guard against the practice of phishing.

Since phishing is generally viewed as a subset of spam, one manner of attacking the phishing problem is through use of spam filters implementing various spam detection strategies. Generally, however, spam filters known in the art are not well-suited to detecting phishing emails. Some prior art spam filtering strategies and their problems are as follows:

Bayesian filtering. A Bayesian filter uses a mathematical algorithm (i.e., Bayes' Theorem) to derive a probability that a given email is spam, given the presence of certain words in the email. However, a Bayesian filter does not know the probabilities in advance and must be “trained” to effectively recognize what constitutes spam. Consequently, the filter does not perform well in the face of “zero-day attacks” (i.e., new attacks that it has not been trained on). Further, a spammer can degrade the effectiveness of a Bayesian filter by sending out emails with large amounts of legitimate text. Still further, a Bayesian filter is very resource intensive and requires substantial processing power.

Black and/or white lists. Some spam filters use network information (e.g., IP and email addresses) in the email header to classify an incoming e-mail into black and/or white lists in order to deny or to allow the email. A black list comprises a list of senders that are deemed untrustworthy whereas a white list comprises a list of senders that are deemed trustworthy. The disadvantages of black and white lists are many and include, inter alia: an “introduction problem” whereby an incoming legitimate email will not penetrate a white-list based filter if it is from a sender that has not yet conversed with the recipient (and hence, the sender does not appear on the white list); in the case of black lists, the filter can introduce false positives and will not perform well in the face of zero-day attacks (e.g., a spammer can circumvent the filter by using IP addresses that do not appear on the black list); and in the case of both black and white lists, there is a management problem of maintaining and periodically adjusting the lists to add or remove certain senders.

Keyword analysis. Some spam filters analyze keywords in the email header or body to detect indicia of spam. However, a spammer can degrade the effectiveness of a keyword filter by obfuscating keywords or composing the email with images (e.g., Graphics Interchange Format (GIF) images). Further, there is a management problem of maintaining and periodically adjusting a dictionary of keywords that are indicative of spam.

Accordingly, in view of the problems associated with existing spam detection strategies in detecting phishing attacks, there is a need to develop alternative, or at least supplemental strategies and mechanisms to guard against the practice of phishing. Advantageously, the new strategies will not require training filters, maintaining black or white lists or performing keyword analysis. The present invention is directed to addressing this need.

### SUMMARY OF THE INVENTION

This need is addressed and a technical advance is achieved in the art by a phishing filter that employs a set of heuristics or rules (e.g., 12 rules) to detect and filter phishing attempts solicited by electronic mail. The phishing filter does not need to be trained, does not rely on black or white lists and does not perform keyword analysis. The filter has been demonstrated to outperform existing filters with use of the entire set of 12 rules in combination, however the filter may be implemented and beneficial results achieved with selected individual rules or selected subsets of the 12 rules. The filter may be implemented as an alternative or supplemental to prior art spam detection filters.

In one embodiment, there is provided a phishing filter adapted to execute one or more heuristics to detect phishing attempts solicited by email. The phishing filter comprises (a) a login URL analysis element operable to identify and analyze a login URL of an email under review for indicia of phishing; (b) an email header analysis element operable to analyze a chain of SMTP headers in the email under review for indicia of phishing; (c) an other URL analysis element operable to analyze URLs other than the login URL in the email under review for indicia of phishing; (d) a website accessibility determination element operable to determine if the login URL of the email under review is accessible; and (e) means for producing an output metric responsive to elements (a), (b), (c) and (d) that characterizes the likelihood of the email under review comprising a phishing attempt.

In another embodiment, there is provided a method for evaluating an email for indicia of phishing, applicable to an email having a login URL and a display string comprising a URL. The method comprises determining whether the URL shown in the display string indicates use of Transport Layer Security (TLS); determining whether the login URL indicates use of TLS; producing a metric indicative of a valid email if TLS is indicated in both the URL shown in the display string and the login URL; and producing a metric indicative of a phishing email if TLS is indicated in the URL shown in the display string but not in the login URL.

In yet another embodiment, there is provided a method for evaluating an email for indicia of phishing, applicable to an email having a login URL including a path component and a host component, the host component having a domain portion. The method comprises determining if a business name appears in the path component; producing a metric indicative of a phishing email if a business name appears in the path component; if a business name does not appear in the path component, determining if a business name appears in the host component; producing a metric indicative of a valid email if a business name does not appear in the host component or if a business name appears in the domain portion of the host component; and producing a metric indicative of a phishing email if a business name appears in the host component but not in the domain portion of the host component.

In yet another embodiment, there is provided a method for evaluating an email for indicia of phishing, applicable to an email having one or more other URLs in addition to a login URL, the other URLs and the login URL each having a DNS domain. The method comprises performing a case-insensitive, byte-wise comparison of the domain of each of the other URLs to the domain of the login URL; producing a metric indicative of a valid email if the domain of each of the other URLs matches the domain of the login URL, otherwise producing a metric indicative of a phishing email.

In still another embodiment, there is provided a method for evaluating an email for indicia of phishing, applicable to an email having one or more other URLs in addition to a login URL, the other URLs and the login URL each having a DNS registrant. The method comprises comparing the DNS registrant associated with each of the other URLs to the DNS registrant associated with the login URL; producing a metric indicative of a valid email if the DNS registrant of each of the other URLs matches the DNS registrant of the login URL, otherwise producing a metric indicative of a phishing email.

### BRIEF DESCRIPTION OF THE DRAWINGS

The foregoing and other advantages of the invention will become apparent upon reading the following detailed description and upon reference to the drawings.

FIG. 1 is a block diagram of a phishing filter operable to implement a set of twelve heuristics or rules to detect phishing emails according to an embodiment of the invention;

FIG. 2 illustrates an example URL useful for describing operation of some of the rules implementable by the phishing filter;

FIG. 3 is a block diagram of a login URL analysis portion of the phishing filter operable to implement six rules (“rules 1-6”) according to an embodiment of the invention;

FIG. 4 is a flowchart showing steps associated with rule 1 implementable by the phishing filter according to an embodiment of the invention;

FIG. 5 is a flowchart showing steps associated with rule 2 implementable by the phishing filter according to an embodiment of the invention;

FIG. 6 is a flowchart showing steps associated with rule 3 implementable by the phishing filter according to an embodiment of the invention;

FIG. 7 is a flowchart showing steps associated with rule 5 implementable by the phishing filter according to an embodiment of the invention;

FIG. 8 is a block diagram of a further URL analysis portion of the phishing filter operable to implement four rules (“rules 8-11”) according to an embodiment of the invention;

FIG. 9 is a flowchart showing steps associated with rule 8 implementable by the phishing filter according to an embodiment of the invention;

FIG. 10 is a flowchart showing steps associated with rule 9 implementable by the phishing filter according to an embodiment of the invention;

FIG. 11 is a flowchart showing steps associated with rule 10 implementable by the phishing filter according to an embodiment of the invention; and

FIG. 12 is a flowchart showing steps associated with rule 11 implementable by the phishing filter according to an embodiment of the invention.

### DESCRIPTION OF THE PREFERRED EMBODIMENT(S)

FIG. 1 illustrates a phishing detection system 100 operable according to principles of the present invention to detect phishing attempts solicited by email 102. At the heart of the phishing detection system is a phishing filter 104 implemented in software residing on a user device (e.g., personal computer, laptop computer, mobile telephone, Personal Digital Assistant (PDA)) or network device. The phishing filter 104 is adapted to operate on emails 102 that instruct the recipient to log into a web site and which contain a “login URL” (a Uniform Resource Locator, or URL, found within the email that directs the recipient to the sender's login page). The phishing filter 104 employs a plurality of heuristics or rules (e.g., 12 rules) to analyze the text within an email, the email headers and the URLs appearing within the email for indicia of phishing attempts. For example and without limitation, the phishing filter 104 may be implemented using programming languages such as PERL and JAVA. In one embodiment, the phishing filter processes the raw email in ASCII format (American Standard Code for Information Interchange), including Simple Mail Transfer Protocol (SMTP) headers and all formatting tags, such as html tags. Other encodings, such as UTF-8, are converted into ASCII prior to processing. The analysis works for either text-based or html (hypertext markup language) formatted emails 102.

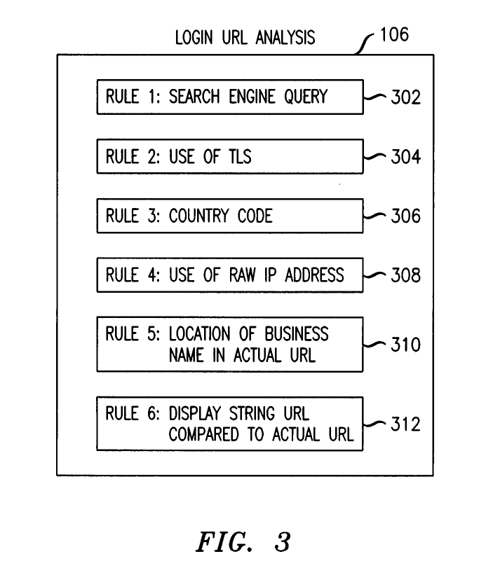

The rules are executed by functional elements including: a login URL analysis element 106 operable to identify and analyze the login URL; an email header analysis element 108 operable to analyze the chain of SMTP headers in the email 102; an “other” URL analysis element 110 operable to analyze URLs other than the login URL; and a website accessibility determination element 112 operable to determine if the login URL is accessible. The rules will be described in detail in relation to FIGS. 3 through 12. As will be appreciated, the filter may operate to execute selected individual rules or subsets of rules described herein. The filter may be implemented as an alternative or supplemental to prior art spam detection filters.

In one embodiment, responsive to executing the plurality of rules on a target email, the phishing filter produces an output metric (“score”) 114 indicative of the probability that the email is a phishing attempt. Thereafter, depending on the output score, the email can be redirected or treated accordingly. For example and without limitation, if the output score is characteristic of a phishing email, the email can be blocked from the users email inbox and redirected to a junk email folder, the links in the email may be disabled, or a warning message may be introduced to warn the user that the email is suspected to be a phishing email.

In one embodiment, the output score 114 is produced by assigning to each rule a configurable weight, Wᵢ and an indicator, Pᵢ, ranging from 0.0 to 1.0, whereby a value of 1 indicates a positive result (i.e., indicative of a phishing email) and a value of 0 indicates a negative result (i.e., indicative of a valid email); and an applicability factor Xi, whereby Xi=1 if the rule is applicable; otherwise Xi=0 if the rule is not applicable. A final score S is based on a weighted sum of the points assigned by the rules divided by a weighted sum of the number of rules applied:

$$s = \frac{\sum {W}_{i} {P}_{i}}{\sum {W}_{i} {X}_{i}}$$

S indicates the probability that the email is a phishing attempt. The higher the score, the more likely the email is a phishing email. As will be appreciated, the output score may be computed using alternative algorithms, different values, etc. and may be constructed such that a lower, rather than higher, score represents a greater likelihood of phishing.

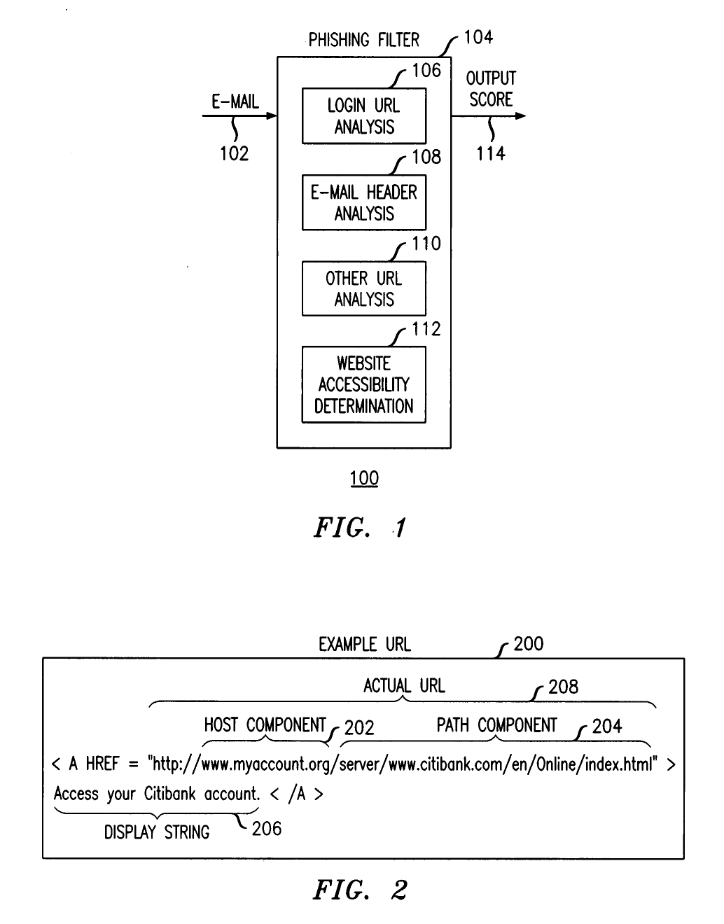

FIG. 2 shows an example URL 200 useful for describing operation of some of the rules implementable by the phishing filter and to establish a common vocabulary of terms. The example URL 200 is depicted in the form of an anchor element (i.e., a link created using <A> elements) in HTML. The term “actual URL” 208 (a.k.a., “login URL”) refers to the value of the HREF parameter (HREF is an acronym for Hypertext REFerence) continuing until the ending right quotation mark. The actual URL comprises an HTTP (Hypertext Transfer Protocol) header (as shown, http://), a host component 202 (in the example, www.myaccount.org) and a path component 204 (in the example, server/www.citibank.com/en/Online/index.html) that represents the resource to be accessed. Following the actual URL is a display string 206 (in the example, Access your Citibank account) that is made visible to the user and available to click on to access the site (i.e., in the case of a phishing attempt, a fraudulent site).

FIG. 3 is a block diagram of the login URL analysis element 106 of the phishing filter 104. In one embodiment, the URL analysis element 106 executes six heuristics or rules (e.g., rules 1-6) to identify and analyze the actual URL 208. Rule 1 is a search engine query 302 wherein business names and frequently used terms extracted from the email are entered as search terms using a search engine (e.g., Google, Yahoo or the like) and the top search results are used to determine the legitimate URL of the business. The legitimate URL is then compared to the actual URL to determine whether the rule indicates a positive or negative result. Rule 2 is a TLS query 304 wherein the presence or absence of Transport Layer Security (TLS) is used to indicate a negative or positive result. Rule 3 is a country or region query 306. Rule 4 is an IP address query 308 where the presence or absence of a “raw” IP address (i.e., a number specifying a computer network address) is used to indicate a positive or negative result. Rule 5 is a location of business name query 310 whereby the location of the business name within the actual URL is used to indicate a positive or negative result. Rule 6 is a display string query 312 where if the display string is composed of a URL, it is compared to the actual URL to indicate a positive or negative result.

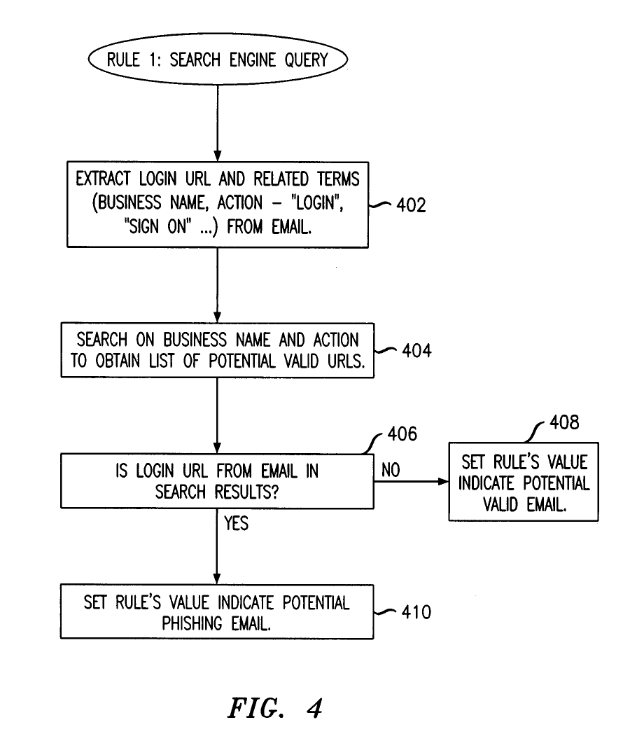

Referring to FIG. 4, a method for executing Rule 1 includes a first step 402 in which the email is parsed to extract the actual URL, business name(s) and frequently used terms. The business name(s) refers to the business or service entity (e.g., banks, credit card issuers, e-commerce enterprises) from which the email appears to have been sent. In one embodiment, the frequently used terms comprise “action” terms (i.e., prompting user activity) typically associated with login pages, for example and without limitation, terms such as “login, “sign on,” “click here,” “account access” or the like but do not include common terms (for example, days of the week, months of the year or generic terms such as “statement” or “online”) that do not prompt user action.

At step 404, the extracted terms are used as search terms using a search engine (e.g., Google, Yahoo or the like) and a list of search results is obtained to determine the legitimate URL of the business. The results can be cached to avoid repeated queries for emails containing the same business. The correct URL, especially for major businesses, is typically within the top search results. For example, the legitimate URL may be determined to correspond to the first n search results, where n is configurable (n=5 is a value used by applicants with effective results). It is noted, the possibility exists that the top search results may include an illegitimate URL associated with a phishing site, for example, if a spammer practices what has been referred to as “Google bombing” or “link bombing” to insert a phishing site into the top search results. This is a valid concern but it can be mitigated by conducting a search across two or more search sites and comparing the results using statistical analysis techniques to derive a list of prospective valid URLs.

At step 406, the domain found in the host component of the actual URL from the email is compared to the domain of the top search results and it is determined whether a match occurs (i.e., is the actual URL from the email in the top search results). If a match occurs, Rule 1 yields a negative result and a value indicative of a potential valid email is assigned at step 408. If a match does not occur, Rule 1 yields a positive result and a value indicative of a potential phishing email is assigned at step 408.

FIG. 5 shows a method for executing Rule 2 (i.e., a TLS query) analysis of the actual URL in relation to the display string (i.e., in cases where the display string 206 comprises a URL.) At step 502, a determination is made whether the URL shown in the display string 206 indicates use of Transport Layer Security (TLS). By way of background, TLS is a cryptographic protocol sometimes used in conjunction with HTTP to secure web applications including, for example, e-commerce and asset management applications, using a digital “certificate” (e.g., an X.509 certificate) for authentication of one or more endpoints. The use of TLS is customarily indicated by an https://syntax. Accordingly, in one embodiment, a positive determination will result at step 502 if the URL shown in the display string 206 uses a https://syntax and a negative determination will result if the URL shown in the display string does not use a https://syntax. In response to a negative determination at step 502, the TLS analysis ends at step 504 and Rule 2 is given no weight, thus yielding no impact on the output score.

If a determination is made at step 502 that the URL shown in the display string 206 uses TLS, it is determined at step 506 whether the actual URL 208 uses TLS as well. For example, in one embodiment, a positive determination will result at step 506 if the actual URL 208 uses a https://scheme and a negative determination will result if the actual URL 208 does not use a https://scheme.

If it is determined at step 506 that the actual URL 208 does not use TLS, Rule 2 yields a positive result and a value indicative of a potential phishing email is assigned at step 508.

If it is determined at step 506 that the actual URL 208 uses TLS, further analysis is performed to determine if the email is likely to be a phishing email or a valid email. In one embodiment, this analysis involves a comparison of the digital certificate (e.g., the X.509 certificate) retrieved and cached (saved) on a previous visit to a site to the certificate obtained on subsequent visits. For example, a cached X.509 certificate retrieved from a legitimate site (e.g., obtained on a first visit to the site) can be compared to the X.509 certificate on subsequent visits to detect instances where the site has been compromised to redirect users to an illegitimate site having a fraudulent X.509 certificate.

In one embodiment, following a determination that the actual URL uses TLS, it is initially determined at step 510 whether a certificate for the site already exists in a certificate “keyring” (i.e., is there already a cached X.509 certificate associated with a previous visit to the site). If a cached certificate does not already exist (which may occur, for example, upon a user's first visit to the site), the certificate associated with the site is retrieved, validated and saved at step 512 and a value indicative of a potential valid email is assigned at step 516.

If a cached certificate does exist, a certificate is obtained from the site and compared to the cached certificate at step 514. If the cached certificate and the certificate associated with the present site are the same, Rule 2 yields a negative result and a value indicative of a potential valid email is assigned at step 516. If they differ, Rule 2 yields a positive result and a value indicative of a potential phishing email is assigned at step 508.

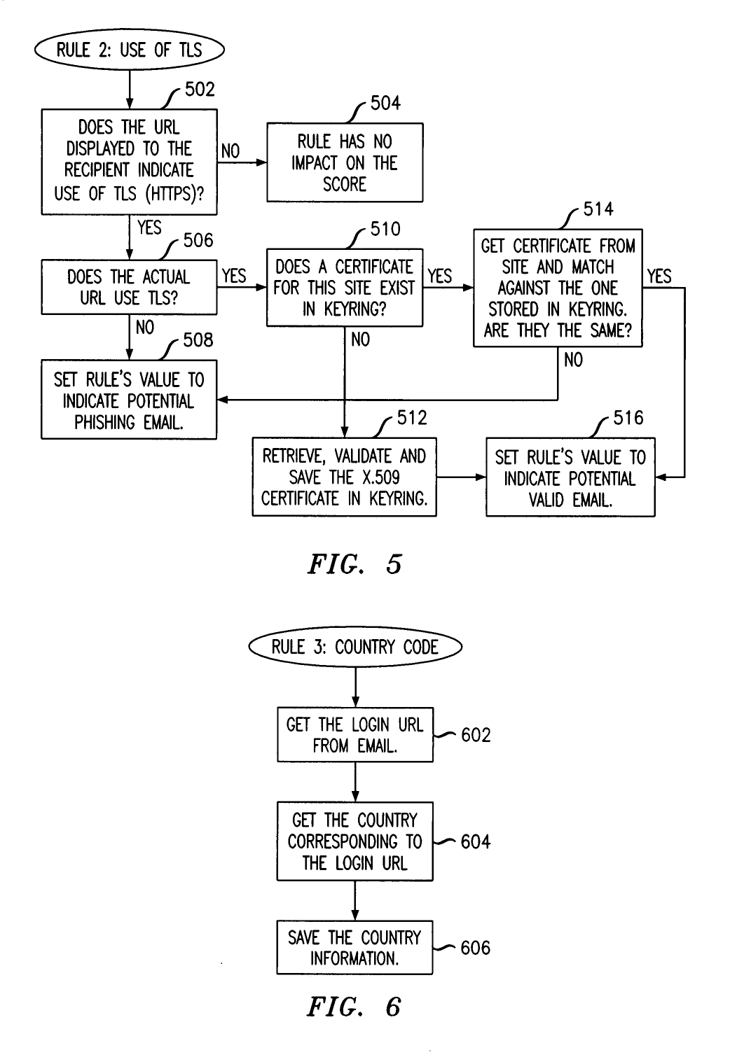

FIG. 6 shows a method for executing Rule 3 (i.e., a country or region) analysis of the actual URL. At step 602, the email is parsed to extract the actual (or “login”) URL. At step 604, a country is or region associated with the actual URL is obtained.

In one embodiment, the country or region is obtained by determining the IP address associated with the actual URL and then searching a database that maps IP addresses to country codes. The country information is saved at step 606. In one embodiment, the country or region information is used for information purposes but does not contribute to the overall score of the phishing filter. Alternatively, of course, other embodiments may utilize the country information to contribute to the overall score or to influence in some manner a final determination of the presence or absence of phishing.

In Rule 4 (no flowchart shown), it is determined whether the actual URL is referenced using a “raw” IP address (i.e., a number specifying a computer network address) instead of a domain name. It is presumed that a login page of an illegitimate site may use a raw IP address and an authentic login page is less likely to use a raw IP address. Accordingly, if the actual URL uses a raw IP address, Rule 4 indicates a positive result (i.e., indicative of a phishing email). Conversely, Rule 4 indicates a negative result if the actual URL does not use a raw IP address.

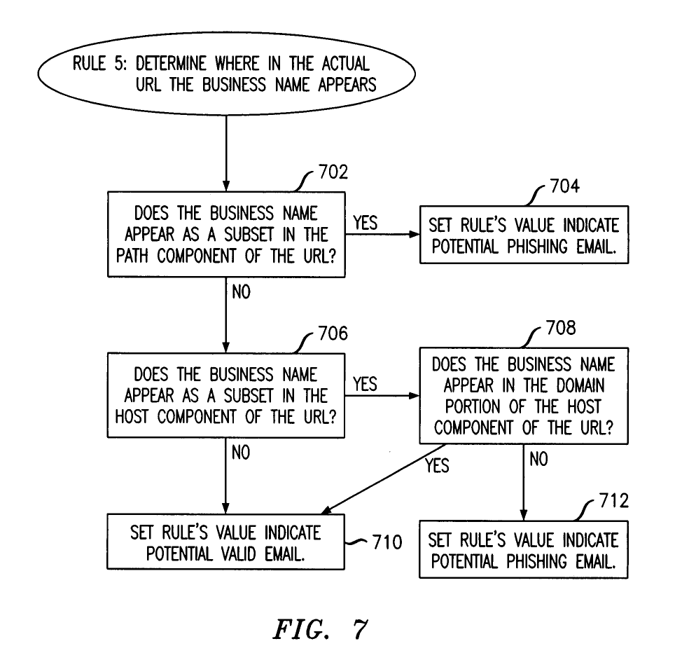

FIG. 7 shows a method for executing Rule 5 (i.e., location of business name) analysis of the actual URL. With reference to FIG. 2, the method presumes that a phishing email is likely to embed a business name (as shown, “citibank”) in either the host component 202 or path component 204 of the actual URL 208.

At step 702, a determination is made whether the business name appears in the path component of the actual URL. If the business name does appear in the path component (as it does in the exemplary URL of FIG. 2), Rule 5 indicates a positive result and a value indicative of a potential phishing email is assigned at step 704. If the business name does not appear in the path component, the method proceeds to step 706 to determine whether the business name appears in the host component.

If the business name appears in the host component but not the path component, Rule 5 may indicate a positive or negative result depending on which portion of the host component the business name appears. In one embodiment, it is presumed that a business name appearing in the “domain” portion of the host component is likely to indicate a valid email. The domain portion is the portion (in FIG. 2, “myaccount.org”) following the www header of the host component. If the business name appears in the domain portion of the host component, determined at step 708, Rule 5 indicates a negative result and a value indicative of a potential valid email is assigned at step 710. If not, Rule 5 indicates a positive result and a value indicative of a potential phishing email is assigned at step 712.

In Rule 6 (no flowchart shown), if the display string 206 of the URL is composed of a URL, it is compared to the actual URL 208. If the domains do not match, Rule 6 indicates a positive result, otherwise if the domains match, Rule 6 indicates a negative result.

Rule 7 (no flowchart shown) is a rule executed by the email header analysis element 108 of the phishing filter in one embodiment of the invention. In Rule 7, the chain of “Received” Simple Mail Transfer Protocol (SMTP) headers is checked to determine if the path included a server (based on DNS domain) or a mail user agent in the same DNS domain as the business. Under normal circumstances, the mail user agent originating the email or at the very least, a SMTP relay handling the email will be in the same DNS domain as that of the business. Rule 7 indicates a negative result if such a Received header is present, otherwise Rule 7 indicates a positive result.

For example, an email with the From header and message body indicating it is for Chase bank but without any “Received” lines containing an SMTP relay or a mail user agent in the chase.com DNS domain would be marked positive. While headers inserted by mail user agents such as To, From, and Subject are easy to spoof, it is more difficult, though not impossible, to alter the headers such as “Received” by adding intermediaries. In the event that the “Received” header is forged, Rule 7 may return a negative result (0 points), but the result will have to compete with the remaining rules in order to contribute to the final score. That is, even though Rule 7 may return a negative result in the given example, the final score after application of multiple rules may nevertheless indicate a phishing email.

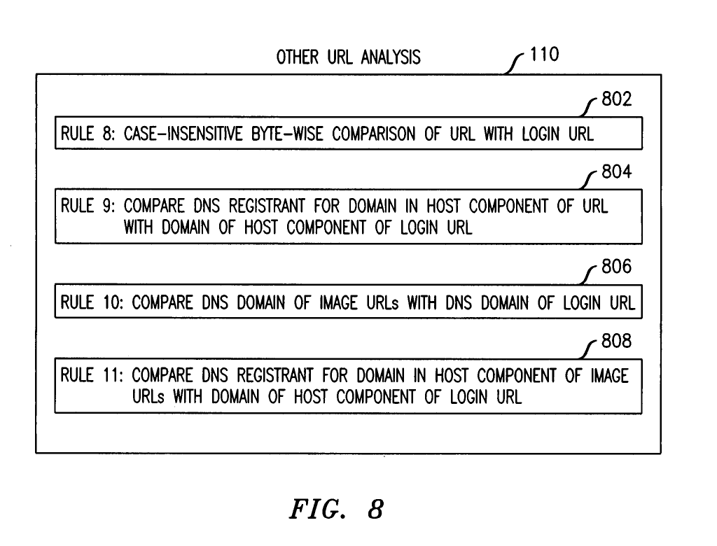

FIG. 8 is a block diagram of the “other” URL analysis element 10 of the phishing filter operable to analyze URLs other than the login URL. In one embodiment, the other URL analysis element 110 executes four heuristics or rules (e.g., rules 8-11) to identify and analyze URLs other than the login URL. URLs that textually display information to the recipient (e.g., a link to the help desk) as well as those that use images are analyzed for inconsistencies. Two rules (rules 8 and 9) apply to URLs for links to web pages and two rules (rules 10 and 11) apply to links for images. Inconsistencies arise in circumstances where the login URL points to a fake website while the other URLs are actual links from the real website or are links to pages stored on some other site; such inconsistencies point to the potential for a phishing message. Rules 8-11, represented in FIG. 8 by respective functional blocks 802, 804, 806 and 808, will be described in greater detail in relation to FIGS. 9-12.

Referring to FIG. 9, a method for executing Rule 8 includes a first step 902 wherein, for each URL in the email except the login URL, there is performed a case-insensitive byte-wise comparison of the domain of the URL with the domain of the login URL. If all URLs contain the same domain as the login URL, Rule 8 produces a negative result and a value indicative of a potential valid email is assigned at step 904. However, if any URLs contain a different domain than the login URL, Rule 8 produces a positive result and a value indicative of a potential phishing email is assigned at step 906.

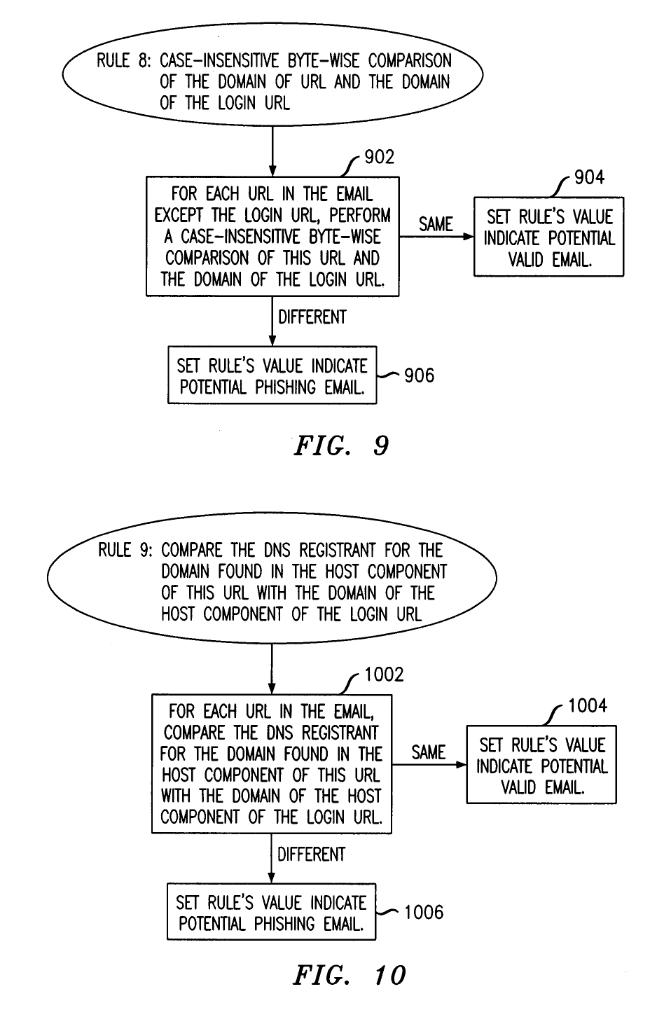

FIG. 10 shows a method for executing Rule 9. This rule takes the same set of URLs in Rule 8 but compares at step 1002, the respective DNS registrants for the domain found in the host component of the URL and the domain of the host component of the login URL. In one embodiment, this is accomplished by performing a whois query to the assigning authority (e.g., using the syntax whois (“domain”)) for the respective domains. The response to the whois query will yield the DNS registrant for the respective domains; and these DNS registrants are compared at step 1002. If the DNS registrant information is the same for all URLs, Rule 9 produces a negative result and a value indicative of a potential valid email is assigned at step 1004. Otherwise Rule 9 produces a positive result and a value indicative of a potential phishing email is assigned at step 1006. In one embodiment, the point value assigned for a positive result of Rule 9 corresponds to the percentage of URLs whose information differs from the login URL.

Three advantageous aspects of Rule 9 are noted herein for example and without limitation. First, this rule allows the phishing filter to be impervious to mergers and acquisitions, a common occurrence in the banking industry. For example, consider the acquisition of Bank One by Chase: under this rule, whois (“bankone.com”) and whois (“chase.com”) both yield JPMorgan Chase & Co. as the registrant, yielding a negative result (i.e., indicating a valid email). Second, this rule helps in content hosting where a business accesses its contents from another domain owned by it. For example, ebay.com stores static content on (and accesses it from) the domain ebaystatic.com. Third, this rule aids in cases where the business uses a URL not containing their domain name but which is registered to the business nonetheless. Emails from such businesses may display a URL to the recipient that includes the business name while the actual URL does not contain the business name. A well-known example is the “accountonline.com” domain: this domain is registered to Citibank, NA, but it is hard to reach that conclusion by just examining the domain name.

FIG. 11 shows a method for executing Rule 10. This rule is similar in concept to Rule 8, except that it is applicable to “image” URLs (i.e., URLs that link to images). At step 1102, for each image URL in the email, there is performed a case-insensitive byte-wise comparison of the DNS domain of the URL with the DNS domain of the login URL. If all image URLs contain the same domain as the login URL, Rule 10 produces a negative result and a value indicative of a potential valid email is assigned at step 1104. However, if any URLs contain a different domain than the login URL, Rule 10 produces a positive result and a value indicative of a potential phishing email is assigned at step 1106.

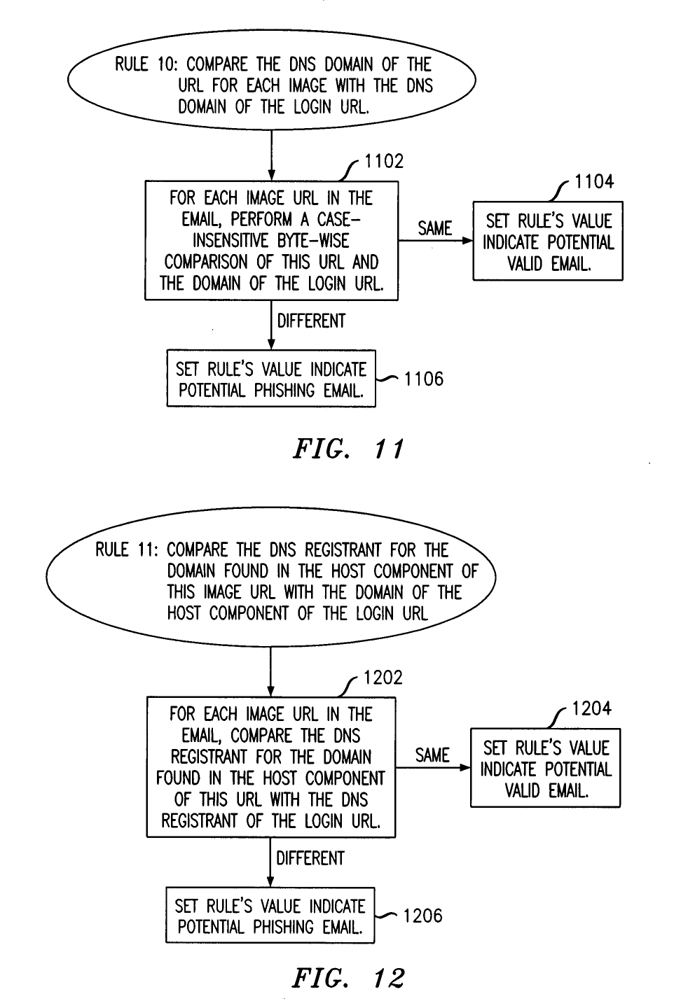

FIG. 12 shows a method for executing Rule 11. This rule is similar in concept to Rule 9 except that it is applicable to image URLs (i.e., the same set of image URLs as analyzed in Rule 10). At step 1202, for each of the image URLs under review, the DNS registrant for the domain found in the host component of the URL is compared with the domain of the host component of the login URL. The whois registrant information for each URL is compared to the whois registrant information of the login URL. If the information is the same for all URLs, Rule 11 produces a negative result and a value indicative of a potential valid email is assigned at step 1204. Otherwise Rule 11 produces a positive result and a value indicative of a potential phishing email is assigned at step 1206. In one embodiment, the point value assigned for a positive result of Rule 11 corresponds to the percentage of image URLs whose information differs from the login URL.

Rule 12 (no flowchart shown) is a rule executed by the website accessibility determination element 112 of the phishing filter in one embodiment of the invention. In Rule 12, a final check determines if the login URL is accessible (i.e., whether the resource represented by the URL can be accessed). The rule presumes that if the web page is inaccessible, it is likely to be a phishing site that has been disabled. In one embodiment, the rule produces a positive result if the web page is inaccessible; otherwise the rule is considered not applicable, in order to avoid lowering the score for an active phishing site.

The present disclosure has therefore identified a phishing filter operable to exercise 12 rules to detect and filter phishing attempts solicited by electronic mail. The phishing filter may be implemented with all or part of the rules; and may be implemented as an alternative or supplemental to prior art spam detection filters. It should also be understood that the steps of the methods set forth herein are not necessarily required to be performed in the order described, additional steps may be included in such methods, and certain steps may be omitted or combined in methods consistent with various embodiments of the present invention.

The present invention can be embodied in the form of methods and apparatuses for practicing those methods. The present invention can also be embodied in the form of program code embodied in tangible media, such as USB flash drives, CD-ROMs, hard drives or any other machine-readable storage medium, wherein, when the program code is loaded into and executed by a machine, such as a computer or processor, the machine becomes an apparatus for practicing the invention. The present invention can also be embodied in the form of program code, for example, whether stored in a storage medium, loaded into and/or executed by a machine or transmitted over some transmission medium or carrier, such as over electrical wiring or cabling, through fiber optics, or via electromagnetic radiation, wherein, when the program is loaded into and executed by a machine, such as a computer, the machine becomes an apparatus for practicing the invention.

While this invention has been described with reference to illustrative embodiments, the invention is not limited to the described embodiments but may be embodied in other specific forms without departing from its spirit or essential characteristics. The scope of the invention is, therefore, indicated by the appended claims rather than by the foregoing description. All changes that come within the meaning and range of equivalency of the claims are to be embraced within their scope.

What is claimed is:

1. A phishing filter adapted to execute one or more heuristics to detect phishing attempts solicited by email, the phishing filter comprising:
(a) a login URL analysis element operable to identify and analyze a login URL of an email under review for indicia of phishing;
(b) an email header analysis element operable to analyze a chain of SMTP headers in the email under review for indicia of phishing;
(c) an other URL analysis element operable to analyze URLs other than the login URL in the email under review for indicia of phishing;
(d) a website accessibility determination element operable to determine if the login URL of the email under review is accessible; and
(e) means for producing an output metric responsive to elements (a), (b), (c) and (d) that characterizes the likelihood of the email under review comprising a phishing attempt.

2. The phishing filter of claim 1, wherein the heuristics executable by the login URL analysis element include a TLS query whereby indicia of phishing is determinable by use of Transport Layer Security in portions of the email under review including the login URL.

3. The phishing filter of claim 1, wherein the heuristics executable by the login URL analysis element include a location of business name query whereby indicia of phishing is determinable by the location of a business name in portions of the login URL.

4. The phishing filter of claim 1, wherein the heuristics executable by the login URL analysis element are selected from the group consisting of a search engine query, a TLS query, a country query, an IP address query, a location of business name query and a display string query.

5. The phishing filter of claim 1, wherein the heuristics executable by the other URL analysis element include a domain query whereby indicia of phishing is determinable by comparing domains of one or more other URLs relative to the domain of the login URL.

6. The phishing filter of claim 1, wherein the heuristics executable by the other URL analysis element include a DNS registrant query whereby indicia of phishing is determinable by comparing the DNS registrant associated with one or more other URLs relative to the DNS registrant of the login URL.

7. A method for evaluating an email for indicia of phishing, applicable to an email having a login URL and a display string comprising a URL, the method comprising:
determining whether the URL shown in the display string indicates use of Transport Layer Security (TLS);
determining whether the login URL indicates use of TLS;
producing a metric indicative of a valid email if TLS is indicated in both the URL shown in the display string and the login URL; and
producing a metric indicative of a phishing email if TLS is indicated in the URL shown in the display string but not in the login URL.

8. The method of claim 7, further comprising responsive to producing a metric indicative of a valid email:
retrieving and saving a digital certificate associated with the website prompted by the email, yielding a saved certificate;
on one or more subsequent visits to the website, characterizing a present status of the website by retrieving a digital certificate from the website and comparing to the saved certificate, the present status characterizing a compromised state if the digital certificate retrieved from the website does not match the saved certificate.

9. A method for evaluating an email for indicia of phishing, applicable to an email having a login URL including a path component and a host component, the host component having a domain portion, the method comprising:
determining if a business name appears in the path component;
producing a metric indicative of a phishing email if a business name appears in the path component;
if a business name does not appear in the path component, determining if a business name appears in the host component;
producing a metric indicative of a valid email if a business name does not appear in the host component or if a business name appears in the domain portion of the host component; and
producing a metric indicative of a phishing email if a business name appears in the host component but not in the domain portion of the host component.

10. A method for evaluating an email for indicia of phishing, applicable to an email having one or more other URLs in addition to a login URL, the other URLs and the login URL each having a DNS domain, method comprising:
performing a case-insensitive, byte-wise comparison of the domain of each of the other URLs to the domain of the login URL;
producing a metric indicative of a valid email if the domain of each of the other URLs matches the domain of the login URL, otherwise producing a metric indicative of a phishing email.

11. The method of claim 10, wherein at least a portion of the one or more other URLs comprise links to websites that display textual information.

12. The method of claim 10, wherein at least a portion of the one or more other URLs comprise links to websites that display images.

13. A method for evaluating an email for indicia of phishing, applicable to an email having one or more other URLs in addition to a login URL, the other URLs and the login URL each having a DNS registrant, method comprising:
comparing the DNS registrant associated with each of the other URLs to the DNS registrant associated with the login URL;
producing a metric indicative of a valid email if the DNS registrant of each of the other URLs matches the DNS registrant of the login URL, otherwise producing a metric indicative of a phishing email.

14. The method of claim 13, wherein at least a portion of the one or more other URLs comprise links to websites that display textual information.

15. The method of claim 13, wherein at least a portion of the one or more other URLs comprise links to websites that display images.
